(19) United States
(12) Patent Application Publication
(10) Pub. No.: US 2017/0039585 A1
(43) Pub. Date: Feb. 9, 2017

(54) APPARATUS AND METHOD FOR CONVERTING PRINT MEDIA COUPONS TO VIRTUAL COUPONS AND REDEEMING SAME

(71) Applicant: Meijer, Inc., Grand Rapids, MI (US)

(72) Inventors: K. Michael Ross, Grand Rapids, MI (US); Lanny Curtis, Howard City, MI (US); Brian Pugh, Grand Rapids, MI (US)

(21) Appl. No.: 15/332,927

(22) Filed: Oct. 24, 2016

Related U.S. Application Data
(63) Continuation of application No. 13/972,154, filed on Aug. 21, 2013.
(60) Provisional application No. 61/692,455, filed on Aug. 23, 2012.

(51) Int. Cl. G06Q 30/02

(52) U.S. Cl. CPC G06Q 30/0224; G06Q 30/0238

(57) ABSTRACT

A print media coupon may be converted to a virtual print media coupon by a device which captures an image of information on the print media coupon and which creates the virtual print media coupon based on the captured image. The virtual print media coupon may be stored in a virtual coupon repository associated with a customer of a retail enterprise that controls the repository, and/or may be stored in another memory. Alternatively or additionally, a virtual print media coupon displayed on a mobile device may be stored in the virtual coupon repository after scanning during the purchase transaction.

### CROSS-REFERENCE TO RELATED APPLICATION

This patent application is a continuation of U.S. application Ser. No. 13/972,154, filed Aug. 21, 2013, which claims the benefit of, and priority to, U.S. Provisional Patent Application Ser. No. 61/692,455, filed Aug. 23, 2012, the disclosures of which are incorporated herein by reference.

### BACKGROUND

Retailers of goods and services may typically offer such goods and services for purchase via one or more conventional brick-and-mortar retail outlets. Such retail outlets may include any number of point-of-sale systems via which customers purchase items selected while shopping according to a so-called “checkout” process. Retailers may additionally or alternatively operate one or more on-line services via which customers may purchase items.

Retailers may further offer virtual coupons to customers, and such virtual coupons may be stored in a database and accessed by customers via a virtual customer coupon service to automatically redeem the virtual coupons during purchase of goods and/or services. Manufacturers of products sold by such retailers may alternatively or additionally offer print media coupons in various print media that may be purchased or otherwise accessed by the public generally. All such virtual and print media coupons provide an economic benefit to customers who shop with such retailers.

### SUMMARY

This present disclosure may comprise one or more of the following features and/or combinations thereof. For example, a device for converting a print media coupon to a virtual print media coupon may comprise a camera to capture an image of coupon information on the print media coupon, and a virtual print media coupon generation module to extract the coupon information from the captured image, to create the virtual print media coupon from the extracted coupon information and to store the created virtual print media coupon in a memory. The device may further include the memory. Alternatively or additionally, the memory may be part of an external device or system that is separate from the device, wherein the device is coupled to the external device or system via a network. Alternatively or additionally still, the memory may be a virtual coupon repository in a system that is separate from the device.

A method for converting a print media coupon to a virtual print media coupon may comprise capturing an image of coupon information on the print media coupon, extracting the coupon information from the captured image, creating the virtual print media coupon from the extracted coupon information, and storing the created virtual print media coupon in a memory. Storing the created virtual print media coupon may comprise storing the created virtual print media coupon in a memory that is one of on-board a device that captures the image and part of a device or system that is separate from the device that captures the image and accessible to the device that captures the image via a network. Alternatively or additionally, storing the created virtual print media coupon may comprise storing the created virtual print media coupon in a virtual coupon repository within a database of a system that is separate from a device that captures the image, wherein the system is part of a retail business enterprise, and wherein the created virtual print media coupon stored in the virtual coupon repository is automatically or selective redeemable at and by a point-of-sale terminal of the retail business enterprise. In any case, capturing an image of coupon information on the print media coupon may comprise capturing the image using a camera. Illustratively, the print media coupon may be displayed as an image of the print media coupon, and in such cases capturing an image of coupon information on the print media coupon may comprise capturing the coupon information from the displayed image of the print media coupon.

One or more machine readable media may contain instructions for converting a print media coupon to a virtual print media coupon, wherein execution of the instructions by one or more processors may cause the one or more processors to capture an image of coupon information on the print media coupon, extract the coupon information from the captured image, create the virtual print media coupon from the extracted coupon information, and store the created virtual print media coupon in a memory. Execution of the instructions by one or more processors may cause the one or more processors to store the created virtual print media coupon in a memory that is one of on-board the device and part of an external device or system that is accessible to the device via a network. Alternatively or additionally, execution of the instructions by one or more processors may cause the one or more processors to store the created virtual print media coupon in a virtual coupon repository within a database of a system that is separate from the device, wherein the system is part of a retail business enterprise, and wherein the created virtual print media coupon stored in the virtual coupon repository is automatically or selective redeemable at and by a point-of-sale terminal of the retail business enterprise.

A system for converting a print media coupon to a virtual print media coupon may comprise one or more point-of-sale terminals each having an item scanner to scan an image of the virtual print media coupon displayed on a display screen of a mobile device as part of an item purchase transaction by a customer of a retail enterprise controlling the one or more point-of-sale terminals, and a server coupled to the one or more point-of-sale terminals, the server having a virtual coupon module to automatically or selectively store the scanned virtual print media coupon in a virtual coupon repository associated with the customer, wherein the virtual print media coupon is thereafter automatically or selectively redeemable by the customer at and by any of the one or more point-of-sale terminals via the virtual coupon repository.

A method of converting a print media coupon to a virtual print media coupon may comprise scanning with an item scanner of a point-of-sale terminal an image of the virtual print media coupon displayed on a display screen of a mobile device as part of an item purchase transaction by a customer of a retail business enterprise controlling the point-of-sale terminal, and automatically or selectively storing the scanned virtual print media coupon in a virtual coupon repository associated with the customer, the virtual print media coupon thereafter automatically or selectively redeemable by the customer at and by the point-of-sale terminal via the virtual coupon repository.

One or more machine readable media may contain instructions for converting a print media coupon to a virtual print media coupon, wherein execution of the instructions by one or more processors may cause the one or more processors to scan with an item scanner of a point-of-sale terminal an image of the virtual print media coupon displayed on a display screen of a mobile device as part of an item purchase transaction by a customer of a retail business enterprise controlling the point-of-sale terminal, and automatically or selectively store the scanned virtual print media coupon in a virtual coupon repository associated with the customer, wherein the virtual print media coupon is thereafter automatically or selectively redeemable by the customer at and by the point-of-sale terminal via the virtual coupon repository.

A system for converting a print media coupon to a virtual print media coupon may comprise one or more point-of-sale terminals each having an item scanner to scan a print media coupon as part of an item purchase transaction by a customer of a retail enterprise controlling the one or more point-of-sale terminals, and a server coupled to the one or more point-of-sale terminals, the server having a virtual coupon module to automatically or selectively store the scanned print media coupon in the form of a virtual print media coupon in a virtual coupon repository associated with the customer, wherein the virtual print media coupon is thereafter automatically or selectively redeemable by the customer at and by any of the one or more point-of-sale terminals via the virtual coupon repository.

A method of converting a print media coupon to a virtual print media coupon may comprise scanning with an item scanner of a point-of-sale terminal a print media coupon as part of an item purchase transaction by a customer of a retail business enterprise controlling the point-of-sale terminal, and automatically or selectively storing the scanned virtual print media coupon in the form of a virtual print media coupon in a virtual coupon repository associated with the customer, the virtual print media coupon thereafter automatically or selectively redeemable by the customer at and by the point-of-sale terminal via the virtual coupon repository.

One or more machine readable media may contain instructions for converting a print media coupon to a virtual print media coupon, wherein execution of the instructions by one or more processors may cause the one or more processors to scan with an item scanner of a point-of-sale terminal a print media coupon as part of an item purchase transaction by a customer of a retail business enterprise controlling the point-of-sale terminal, and automatically or selectively store the scanned virtual print media coupon in the form of a virtual print media coupon in a virtual coupon repository associated with the customer, wherein the virtual print media coupon is thereafter automatically or selectively redeemable by the customer at and by the point-of-sale terminal via the virtual coupon repository.

A system for converting a print media coupon to a virtual print media coupon and redeeming same may comprise a mobile device having a camera to capture an image of the print media coupon, a display and a virtual print media coupon generation module to create the virtual print media coupon from the captured image and to store the created virtual print media coupon in a memory, and a point-of-sale terminal to process items to be purchased by a customer, to compare the stored virtual print media coupon with the processed items and to deduct a discount amount of the virtual print media coupon from a price of any of the processed items that match the virtual print media coupon.

The system of the preceding paragraph may further comprise a server in communication with the point-of-sale terminal, the server including a database comprising a virtual coupon repository associated with the customer, wherein the memory is the virtual coupon repository. The point-of-sale terminal may obtain the virtual print media coupon by accessing the virtual coupon repository associated with the customer based on information supplied to the point-of-sale terminal by the customer. The point-of-sale terminal may illustratively delete the virtual print media coupon from the virtual coupon repository associated with the customer after deducting the discount amount of the virtual print media coupon from the price of one of the processed items that match the virtual print media coupon.

Alternatively or additionally, the memory may be contained within the mobile device, and the mobile device may further have a processor to control the display of the mobile device to display thereon an image of the virtual print media stored in the memory of the mobile device. The point-of-sale terminal may include a price scanner to obtain the virtual print media coupon by scanning the image of the virtual print media coupon displayed on the display of the mobile device and to thereafter compare the virtual print media coupon with the processed items. The system may further comprise a server in communication with the point-of-sale terminal, the server including a database comprising a virtual coupon repository associated with the customer, and the server may store the virtual print media coupon in the virtual coupon repository associated with the customer after the point-of-sale terminal deducts the discount amount of the virtual print media coupon from the price of one of the processed items that match the virtual print media coupon, wherein the virtual print media coupon is thereafter automatically or selectively redeemable by the customer at and by the point-of-sale terminal via the virtual coupon repository associated with the customer.

A method for converting a print media coupon to a virtual print media coupon and redeeming same may comprise capturing an image of the print media coupon, creating the virtual print media coupon from the captured image, storing the created virtual print media coupon in a memory, processing items to be purchased by a customer at a point-of-sale terminal, comparing via the point-of-sale terminal the stored virtual print media coupon with the processed items, and deducting via the point-of-sale terminal a discount amount of the virtual print media coupon from a price of any of the processed items that match the virtual print media coupon.

Storing the created virtual print media coupon in a memory may comprise storing the created virtual print media coupon in a virtual coupon repository associated with the customer that is contained within a database of a server in communication with the point-of-sale terminal. The method may further comprise obtaining the stored virtual print media coupon, prior to comparing the stored virtual print media coupon with the processed items, by accessing via the point-of-sale terminal the virtual coupon repository associated with the customer based on information supplied to the point-of-sale terminal by the customer. The method may further comprise deleting the stored virtual print media coupon from the virtual coupon repository associated with the customer after deducting the discount amount of the virtual print media coupon from the price of the one of the processed items that match the virtual print media coupon.

Alternatively or additionally, capturing the image of the print media coupon and creating the virtual print media coupon from the captured image may be carried out using a mobile electronic device, and storing the created virtual print media coupon in a memory may comprise storing the created virtual print media coupon in a memory of the mobile electronic device. In such embodiments, the method may further comprise controlling a display of the mobile electronic device to display thereon an image of the virtual print media stored in the memory of the mobile electronic device, and obtaining the virtual print media coupon, prior to comparing the stored virtual print media coupon with the processed items, by scanning the virtual print media coupon displayed on the display of the mobile electronic device with a price scanner coupled to the point-of-sale terminal. The method may further comprise storing the scanned virtual print media coupon in a virtual coupon repository associated with the customer that is contained within a database of a server in communication with the point-of-sale terminal after the point-of-sale terminal deducts the discount amount of the virtual print media coupon from the price of one of the processed items that match the virtual print media coupon, wherein the virtual print media coupon is thereafter automatically or selectively redeemable by the customer at and by the point-of-sale terminal via the virtual coupon repository associated with the customer.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system in which customers at a retail enterprise can redeem virtual coupons, including virtual print media coupons.

FIG. 2 is a simplified block diagram of an embodiment of one of the point-of-sale systems illustrated in FIG. 1.

FIG. 3 is a simplified block diagram of an embodiment of one of the user computing devices illustrated in FIG. 1.

FIG. 4 is a simplified block diagram of an embodiment of an environment of the main server of FIG. 1.

FIG. 5 is a simplified block diagram of an embodiment of an environment of one of the user computing devices illustrated in FIG. 1.

FIG. 6 is a simplified flow diagram of an embodiment of a process for converting a print media coupon to a virtual print media coupon using one of the user computing devices illustrated in FIGS. 1 and 5.

FIG. 7 is a simplified diagram illustrating one of the user computing devices of FIGS. 1 and 5 capturing an image of coupon information on a print media coupon.

FIG. 8 is a simplified block diagram of an embodiment of a virtual customer coupon repository within the server database of the main server, as viewed on a display monitor of one of the user computing devices of FIG. 1, showing an example storage and display of virtual print media coupons captured and stored within the server database by the user computing device.

FIG. 9 is a simplified flow diagram of an embodiment of a process for automatically redeeming one or more virtual coupons stored in a customer's virtual customer coupon repository of the server database, which repository may include one or more virtual print media coupons, as the customer purchases one or more corresponding items at one of the point-of-sale systems illustrated in FIG. 1.

FIG. 10 is a simplified flow diagram of an embodiment of a process for redeeming one or more virtual print media coupons stored in a database outside of the server database according to an alternate embodiment of the process illustrated in FIG. 6.

FIG. 11 is a simplified block diagram illustrating one of the user computing devices of FIGS. 1 and 5 displaying a virtual print media coupon, converted from a print media coupon according to the process illustrated in FIG. 6, for scanning by one of the point-of-sale systems of FIG. 1 at which a customer is purchasing a corresponding item.

FIG. 12 is a simplified flow diagram an embodiment of a process for scanning conventional print media coupons and automatically redeeming the corresponding print media coupons at a point-of-sale system, and then storing, at the customer's option, any such scanned print media coupons in the customer's repository in the form of virtual print media coupons.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, resource partitioning/sharing/duplication implementations, types and interrelationships of system components, and logic partitioning/integration choices are set forth in order to provide a more thorough understanding of the present disclosure. Control structures, gate level circuits, driver circuits and full software instruction sequences have not been shown in detail in order not to obscure the invention. It will be appreciated, however, by one skilled in the art that embodiments of the disclosure may be practiced without such specific details. Those of ordinary skill in the art, with the included descriptions, will be able to implement appropriate functionality without undue experimentation.

References in the specification to “one embodiment”, “an embodiment”, “an example embodiment”, “one illustrative embodiment” etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred. The terms “customer,” “shopper” and “user,” and variants thereof, are used interchangeably in the following description, and such terms should be understood to refer interchangeably to an individual or a predefined group of individuals, e.g., members of a family, employees of a common business entity, etc., who shops at and purchases items from a retail enterprise.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

The term “virtual coupon” (and/or “virtual customer coupon”) is defined for purposes of this disclosure as a discount coupon stored in a memory device in the form of data, information and/or instructions which may be accessed from, re-stored in and/or deleted from a memory by a processor, and which may be manipulated and/or processed by a processor to determine information relating to one or more items to be purchased, examples of which information may include, but should not be limited to, item identification information, item family identification information, item discount amount, in one or more forms and/or types of currency, minimum and/or maximum item quantities subject to the item discount amount, beginning and/or expiration date of the item discount amount, and the like. The term “print media” is defined for purposes of this disclosure as any tangible medium in which graphical and/or textual information, and/or any copy thereof, in whole or in part, is fixed and viewable by humans, with and/or without the aid of vision correction and/or vision enhancement. Some examples of print media may be or include, but should not be limited to, media that disseminates printed matter, such as, but not limited to, newspapers, newsletters, booklets, pamphlets, magazines, trade publications, directories, printed event programs and/or other printed publications, and any copies thereof, in whole or in part, electronic display devices displaying graphical and/or textual information for human viewing, such as, but not limited to, display screens of fixed, desktop and portable computing devices, such as fixed-installation, desktop, personal, lap top and notebook computers, display screens of thin, lean, slim, ultra-thin and/or web-thin client computers, display screens in one or more cloud computing systems, display screens of mobile computing devices such as smart phones, personal data assistants or the like, and any copies, in whole or in part, of any such graphical and/or textual information displayed on such an electronic display device, or the like. The term “print media coupon” is defined for purposes of this disclosure as any discount coupon that is part of, integral with, attached to or otherwise provided with any print media, as the term “print media” is defined above, and/or any virtual coupon, as the term “virtual coupon” is described above, that subsequently is, becomes part of, is or becomes integral with, is or becomes attached to, or is otherwise provided with, print media.

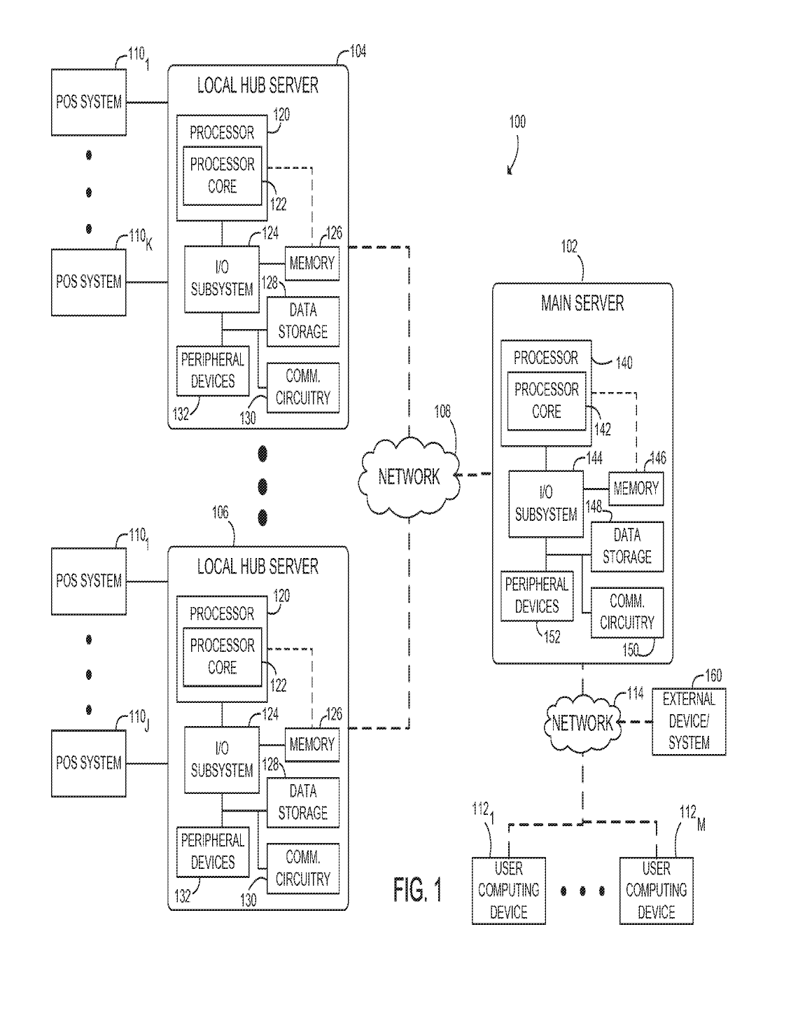

Referring now to FIG. 1, an embodiment of a system 100 is shown in which customers at a retail enterprise can redeem virtual coupons, including virtual print media coupons that have been converted to virtual from print media coupons as described herein. In the illustrated embodiment, the system 100 includes a main server 102 coupled via a network 108 to a plurality of local hub servers 104, 106 each coupled to one or more point-of-sale systems 110₁-110_{K}, 110₁-110_{J}, and each of the point-of-sale systems 110₁-110_{K}, 110₁-110_{J} is configured to process items selected by customers for purchase and to process payment for such items. As discussed in more detail below, the main server 102 includes or otherwise has access to a database, and at least a portion of the database contains a plurality of virtual customer coupon repositories each configured to store and manage virtual coupons for a different one of a corresponding plurality of customers of the retail enterprise. In this regard, the main server 102 may be communicatively coupled at any one time to any number of user computing devices 112₁-112_{M} via a publicly accessible network 114, and customers having virtual customer coupon repositories may use one or more of the user computing devices 112₁-112_{M} to access and manage such repositories via the network 114.

The main server 102 further includes a virtual coupon module which is configured to selectively offer virtual coupons to any of the plurality of customers by selectively transferring one or more such virtual coupons from a virtual coupon database to any of the plurality of virtual customer coupon repositories. As will be discussed in detail below, the one or more user computing devices 112₁-112_{M} may be configured to convert print media coupons to virtual print media coupons for redemption at one of the point-of-sale systems 110₁-110_{K}, 110₁-110_{J}. In one embodiment, any of the one or more user computing devices 112₁-112_{M} may be configured to store one or more such virtual print media coupons in a corresponding customer's virtual customer coupon repository within a server database of the main server 102. The main server 102 is operable to automatically or selectively redeem any such virtual print media coupons stored in a customer's virtual customer coupon repository that match one or more corresponding items purchased by the customer via one of the point-of-sale systems 110₁-110_{K}, 110₁-110_{J}. Alternatively or additionally, any of the one or more user computing devices 112₁-112_{M} may be configured to store one or more such virtual print media coupons in an on-board database or a database that is external to, and separate from, the user computing device 112₁-112_{M} and the sever database of the main server 102. In either case, any such stored virtual print media coupon may be displayed on a display screen of a customer's user computing device 112₁-112_{M}, such as during purchase of items at a point-of-sale system 110₁-110_{K}, 110₁-110_{J}, and the point-of-sale system 110₁-110_{K}, 110₁-110_{J} may then scan or otherwise process the image of the virtual print media coupon displayed on the display screen and redeem the virtual print media coupon if it matches one or more of the items being purchased. In some embodiments, the main server 102 may be configured to automatically or selectively add the scanned virtual print media coupon to the customer's virtual coupon repository. In some embodiments, a customer may present a conventional print media coupon, e.g., a paper coupon, during purchase of items at a point-of-sale system 110₁-110_{K}, 110₁-110_{J}, and the point-of-sale system 110₁-110_{K}, 110₁-110_{J} may then scan or otherwise process the conventional print media coupon, automatically or selectively redeem the scanned print media coupon if it matches one or more of the items being purchased, and the main server 102 may be configured to automatically or selectively add the scanned print media coupon to the customer's virtual coupon repository

Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 100 will be illustrated and described in the context of such a larger retail enterprise having a main physical location and two or more physical hub locations. In this regard, the system 100 shown in FIG. 1 illustratively includes the main server 102, which will typically be located at a main business location of the retail enterprise, coupled via the network 108 to two or more local hub servers 104, 106, each of which will typically be located at a different one of the two or more hub locations.

Each hub location may include any number of point-of-sale systems coupled to a corresponding local hub server, and in the embodiment illustrated in FIG. 1, for example, the local hub server 104 is communicatively coupled to “K” such point-of-sale systems 110₁-110_{K}, 110₁-110_{J} where K may be any positive integer, and the local hub server 106 is communicatively coupled to “J” such point-of-sale systems 110₁-110_{J}, where J may be any positive integer and where J may or may not be equal to K. Communicative coupling between the local hub server 104 and the one or more point-of-sale systems 110₁-110_{K}, and between the local hub server 106 and the one or more point-of-sale systems 110₁-110_{J}, may be accomplished using any known hardwire and/or wireless communication coupling, and communications over such hardwire and/or wireless coupling may be accomplished using any known communication protocol.

In some alternative embodiments of such a large retail enterprise, one or more of the local hub servers 104, 106 may be omitted, and the main server 102 may be coupled direction, via the network 108, to the one or more point-of-sale systems 110₁-110_{K}, 110₁-110_{J}, or the main server may be omitted and at least one of the local hub servers 104, 106 may be configured to act as a so-called master server with the remaining local hub servers 104, 106 configured to act as so-called slave servers. In other alternative embodiments in which the retail enterprise includes only a single brick and mortar outlet, the local hub server 104, 106 may be or include the main server 102 or vice versa. For purposes of the following description, any process disclosed as being controlled by the main server 102 may, in some embodiments, instead be controlled, in whole or in part, by one or more local hub servers 104, 106 and vice versa, and/or may be controlled, in whole or in part, by one of point-of-sale systems 110₁-110_{K}, 110₁-110_{J} and vice versa.

The local hub server 104 may be embodied as any type of server (e.g., a web server) or similar computing device capable of performing the functions described herein. In the illustrative embodiment of FIG. 1, the local hub server 104 includes a processor 120, an I/O subsystem 124, a memory 126, a data storage 128, a communication circuitry 130, and one or more peripheral devices 132. In some embodiments, several of the foregoing components may be incorporated on a motherboard or main board of the local hub server 104, while other components may be communicatively coupled to the motherboard via, for example, a peripheral port. Furthermore, it should be appreciated that the local hub server 104 may include other components, sub-components, and devices commonly found in a sever and/or computing device, which are not illustrated in FIG. 1 for clarity of the description.

The processor 120 of the local hub server 104 may be embodied as any type of processor capable of executing software/firmware, such as a microprocessor, digital signal processor, microcontroller, or the like. The processor 120 is illustratively embodied as a single core processor having a processor core 122. However, in other embodiments, the processor 120 may be embodied as a multi-core processor having multiple processor cores 122. Additionally, the local hub server 104 may include additional processors 120 having one or more processor cores 122.

The I/O subsystem 124 of the local hub server 104 may be embodied as circuitry and/or components to facilitate input/output operations with the processor 120 and/or other components of the local hub server 104. In some embodiments, the I/O subsystem 124 may be embodied as a memory controller hub, an input/output controller hub, and a firmware device. In such embodiments, the firmware device of the I/O subsystem 124 may be embodied as a memory device for storing Basic Input/Output System (BIOS) data and/or instructions and/or other information (e.g., a BIOS driver used during booting of the local hub server 104). However, in other embodiments, I/O subsystems having other configurations may be used. For example, in some embodiments, the I/O subsystem 124 may be embodied as a platform controller hub. In such embodiments, the memory controller hub may be incorporated in or otherwise associated with the processor 120, and the processor 120 may communicate directly with the memory 126 (as shown by the dashed line in FIG. 1). Additionally, in other embodiments, the I/O subsystem 124 may form a portion of a system-on-a-chip and be incorporated, along with the processor 120 and other components of the user computing device 104, on a single integrated circuit chip.

The processor 120 is communicatively coupled to the I/O subsystem 124 via a number of signal paths. These signal paths (and other signal paths illustrated in FIG. 1) may be embodied as any type of signal paths capable of facilitating communication between the components of the local hub server 104. For example, the signal paths may be embodied as any number of point-to-point links, wires, cables, light guides, printed circuit board traces, vias, bus, intervening devices, and/or the like.

The memory 126 of the user local hub server 104 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 126 is communicatively coupled to the I/O subsystem 124 via a number of signal paths. Although only a single memory device 126 is illustrated in FIG. 1, the user computing device 104 may include additional memory devices in other embodiments. Various data and software may be stored in the memory 126. For example, one or more operating systems, applications, programs, libraries, and drivers that make up the software stack executed by the processor 120 may reside in memory 126 during execution. The data storage 128 may be embodied as any type of device or devices configured for the short-term or long-term storage of data such as, for example, memory devices and circuits, memory cards, hard disk drives, solid-state drives, or other data storage devices.

The communication circuitry 130 of the local hub server 104 may include any number of devices and circuitry for enabling communications between the local hub sever 104 and the main server 102 and between the local hub server 104 and the one or more point-of-sale systems 110₁-110_{K}. In the illustrated embodiment, for example, communication between the local hub server 104 and the main server 102 takes place wirelessly via the network 108, wherein the network 108 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 104 and the main server 102 may be, in whole or in part, a wired connection. Generally, the communication circuitry 130 may be configured to use any one or more, or combination, of secure and/or unsecure communication protocols to communicate with the main server 102 such as, for example, a wired network communication protocol (e.g., TCP/IP), a wireless network communication protocol (e.g., Wi-Fi®, WiMAX), a cellular communication protocol (e.g., Wideband Code Division Multiple Access (W-CDMA)), and/or other communication protocols. As such, the network 108 may include any number of additional devices, such as additional computers, routers, and switches, to facilitate communications between the local hub server 104 and the main server 102. As discussed hereinabove, communication between the local hub server 104 and the one or more point-of-sale systems 110₁-110_{K}, 110₁-110_{J} may take place via one or more conventional wired or wireless communication interfaces.

In some embodiments, the local hub server 104 may also include one or more peripheral devices 132. Such peripheral devices 132 may include any number of additional input/output devices, interface devices, and/or other peripheral devices. For example, the peripheral devices 132 may include a display, a keyboard, a mouse, audio processing circuitry (including, e.g., conventional amplification circuitry and one or more speakers), and/or other input/output devices, interface devices, and/or peripheral devices.

The local hub server 106 may be substantially similar to the local hub server 104 and include similar components, which have been identified in FIG. 1 with common reference numbers. As such, the description provided above of the components of the local hub server 104 may be equally applicable to those similar components of the local hub server 106 and are not repeated herein so as not to obscure the present disclosure. Of course, it should be appreciated that in some embodiments the local hub server 104, 106 may be dissimilar to each other.

An embodiment of the main server 102 is also illustrated in FIG. 1, and generally includes the same components as the local hub server 104. For example, a processor 140, having a processor core 142, is coupled to an I/O subsystem 144, and the I/O subsystem 144 is coupled to a memory 146, a data storage unit 148, communication circuitry 150 and one or more peripheral devices 152. In some embodiments, each of the foregoing components may be identical to corresponding components of the local hub server 104 described above, and a detailed explanation of such components will not be repeated here for brevity. In other embodiments, the main server 102 may be configured differently than the local hub server 104 described above. In any case, the communication circuitry 130 of each of the local hub servers 104, 106 facilitates communication with the communication circuitry 150 of the main server 102 and vice versa so that information can be shared between the main server 102 and each of the one or more local hub servers 104, 106 via the network 108. Although only one such main server 102 is shown in FIG. 1, it should be appreciated that, in other embodiments, the system 100 may include any number of main servers. In any case, the main server 102 may be embodied as any type of server (e.g., a web server) or similar computing device capable of performing the functions described herein.

As briefly described above, the main server 102 may be communicatively coupled at any time via the network 114 to any of a number, M, of user computing devices 112₁-112_{M}, where M may be any positive integer, and the one or more user computing devices 112₁-112_{M} of the system 100 may be embodied as any type of computing device capable of performing the functions described herein. For example, each of the user computing devices 112₁-112_{M} may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and/or to execute electronic game software and related applications. A customer may use multiple different user computing devices 112₁-112_{M} to convert print media coupons to virtual print media coupons, to access that customer's virtual coupon repository within the server database of the main server 102, and/or to access one or more other databases in which one or more virtual print media coupons is/are stored, as will be described in detail below. It will be understood that in the following, descriptions of customer control of one of the user computing devices 112₁-112_{M} to convert a print media coupon to a virtual print media coupon, to store a virtual print media coupon in a memory and/or to select a virtual print media coupon from memory for display on a display screen of the user computing device 112₁-112_{M} therefore may not necessarily all refer to control of the same user computing devices 112₁-112_{M} or even the same type of user computer device 112₁-112_{M}, and that any customer may at any time use any of multiple different types of the user computing devices 112₁-112_{M} for any of the tasks described herein. As one example, which should not be considered limiting in any way, a customer may use a smart phone to convert a print media coupon to a virtual print media coupon, and then transfer the virtual print media coupon from the smart phone to a personal computer for storage in a memory of the personal computer. At some point thereafter, the customer may transfer the stored virtual print media coupon from the personal computer to a tablet computer, and then use the tablet computer at a retail outlet of the retail enterprise to display the virtual print media coupon for scanning and redemption by one of the point-of-sale systems 110₁-110_{K}, 110₁-110_{J} during purchase of one or more corresponding items.

In any case, the communication circuitry 150 of the main server 102 may include any number of devices and circuitry for enabling communications between the main sever 102 and the one or more user computing devices 112₁-112_{M}. In the illustrated embodiment, for example, communication between the main server 102 and the one or more user computing devices 112₁-112_{M} takes place wirelessly via the network 114, wherein the network 114 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the main server 102 and the one or more user computing devices 112₁-112_{M} may be, in whole or in part, a wired connection. Generally, the communication circuitry 150 may be configured to use any one or more, or combination, of secure and/or unsecure communication protocols to communicate with communication circuitry in the one or more user computing devices 112₁-112_{M} such as, for example, a wired network communication protocol (e.g., TCP/IP), a wireless network communication protocol (e.g., WiFi®, WiMAX), a cellular communication protocol (e.g., Wideband Code Division Multiple Access (W-CDMA)), and/or other communication protocols. As such, the network 114 may include any number of additional devices, such as additional computers, routers, and switches, to facilitate communications between the main server 102 and the one or more user computing devices 112₁-112_{M}. In some embodiments, the network 114 and the network 108 may be or include a single network or a single collection of networks, such that the main server 102 communicates with the one or more local hub servers 104, 106 and with the one or more user computing devices 112₁-112_{M} via the same network or collection of networks. In other embodiments, the network 114 is wholly separate from the network 108, such that no part of the network 108 is shared with any part of the network 114 and such that the main server 102 communicates with the one or more local hub servers 104, 106 strictly via the network 108 and with the one or more user computing devices 112₁-112_{M} strictly via the network 114. In any case, any of the one or more user computing devices 112₁-112_{M} and/or the main server 102 may communicate with one or more external devices and/or systems 160 via the network 114. Examples of the one or more external devices and/or systems 160 may include, but should not be limited to, one or more servers and/or other computing device(s) hosting a web site which may be accessed in a conventional manner, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data.

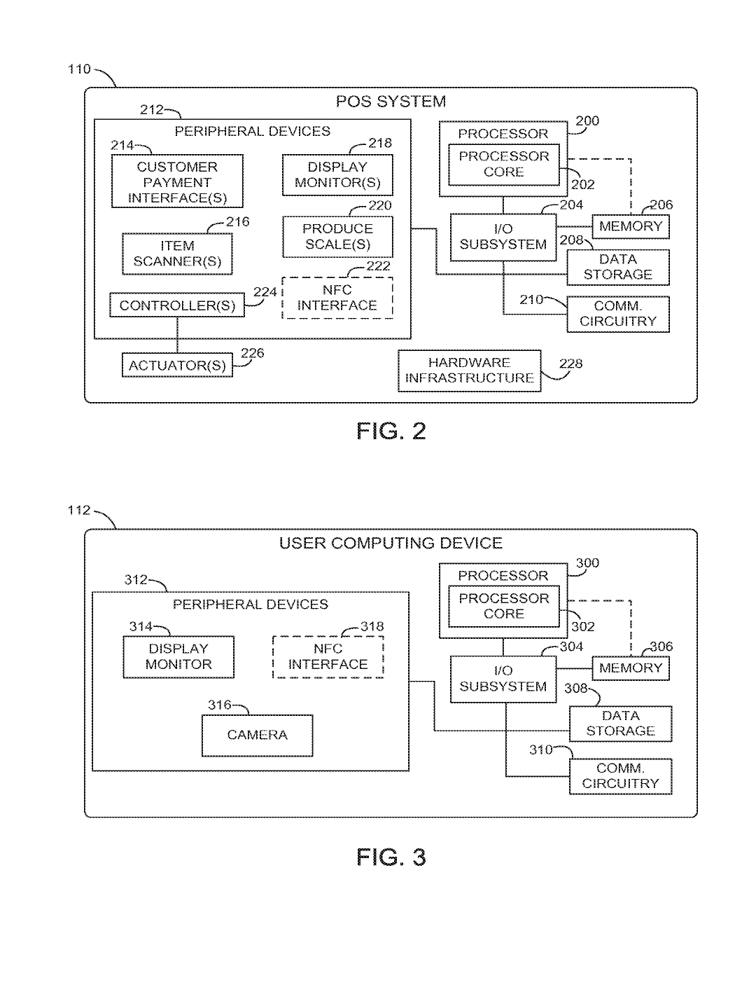

Referring now to FIG. 2, an embodiment 110 of one of the one or more point-of-sale systems 110₁-110_{K}, 110₁-110_{J}, is shown which includes components similar to the main server 102 and also to the one or more local hub servers 104, 106, such as a processor 200, an I/O subsystem 204, a memory 206, a data storage device 208, communication circuitry 210 and a number of peripheral devices 212. In some embodiments, each of the foregoing components may be identical to corresponding components of the local hub server 104 described above, and a detailed explanation of such components will not be repeated here for brevity. In other embodiments, any of the one or more point-of-sale systems 110₁-110_{K}, 110₁-110_{J} may be configured differently than the local hub server 104 described above. Additionally, the illustrated point-of-sale system 110 includes one or more actuators 226 and hardware infrastructure 228, examples of which will be described below. It will be appreciated that the point-of-sale system 110 may include other components, sub-components, and devices commonly found in a computer and/or computing device. In any case, the communication circuitry 210 is configured to facilitate communication with a corresponding one of the local hub servers 104, 106 and the point-of-sale system 110 may use any suitable communication protocol to communicate with the corresponding local hub server 104, 106.

In addition to, or alternatively to, the number of peripheral devices 132 of the local hub server 104 described above, the number of peripheral devices 212 of the point-of-sale system 110 may include any number of other peripheral or interface devices. Examples of some of the peripheral devices 212 illustrated in FIG. 2 include, but should not be limited to, one or more conventional customer payment interfaces 214, one or more conventional item price scanners 216, one or more conventional display monitors 218, one or more conventional produce scales 220 and one or more conventional controllers 224 for controlling one or more conventional actuators 226 associated with the operation of the point-of-sale system 110. The one or more customer payment interfaces 214 are provided, e.g., to facilitate receipt of credit/debit card and/or other form of payment from customers, and each such interface 214 may illustratively include one or more of a display, a touch screen, a keyboard, a mouse, external speakers, and/or other peripheral devices. One or more of the one or more customer payment interfaces 214 may further include a produce scale 220, and one or more produce scales 220 may alternatively be coupled to the point-of-sale system 110 separately from the one or more customer payment interfaces 214. The one or more item scanner(s) 216 is/are configured to scan price code labels or other such indicators for items being purchased by customers and to also scan discount code labels or other such indicators of print media coupons. The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The peripheral devices 212 of the point-of-sale system 110 may further optionally include a near-field communication device 222, as illustrated in dashed-line configuration in FIG. 2, which may be included in embodiments in which one or more of the user computing devices 112₁-112_{M} also has such a near-field communication device such that customer information, e.g., customer identification information in the form of one or more identification codes, user names, passwords, or the like, can be transferred from such one or more of the user computing devices 112₁-112_{M} to the point-of-sale system 110 by tapping the two near-field communication devices together or by passing the near-field communication device of a so-equipped user computing device 112₁-112_{M} sufficiently close to the near-field communication device 222 to effectuate such communication.

The point-of-sale system 110 further includes hardware infrastructure 228 which forms the structural backbone of the point-of-sale system 110. Examples of structural components that may be included in the hardware infrastructure 228 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 226 may be or include any actuator is controllable by at least one of the one or more conventional controllers 224, and which may facilitate operation and/or control of the hardware infrastructure of the point-of-sale system 110. Examples of such one or more actuators may include, but should not be limited to, one or more linear and/or rotational drive motors, one or more electronically controlled switches, and the like.

Referring now to FIG. 3, an embodiment of one of the user computing devices 112 is shown which includes components similar to the main server 102 and also to the one or more local hub servers 104, 106, such as a processor 300, an I/O subsystem 304, a memory 306, a data storage device 308, communication circuitry 310 and a number of peripheral devices 312. In some embodiments, each of the foregoing components may be identical to corresponding components of the local hub server 104 described above, and a detailed explanation of such components will not be repeated here for brevity. In other embodiments, any of the one or more user computing devices 112₁-110_{M} may be configured differently than the local hub server 104 described above. It will be appreciated that the user computing device 112 may include other components, sub-components, and devices commonly found in a computer and/or computing device. In any case, the communication circuitry 310 is configured to facilitate communication with the main server 102 and/or with the one or more other external devices and/or systems 160 via the network 114 as described above, and the user computing device 112 may use any suitable communication protocol to communicate with the main server 102 and/or device(s)/system(s) 160.

The peripheral devices 312 of the user computing device 112 may include any number of peripheral or interface devices. In addition to, or alternatively to the number of peripheral devices 132 of the local hub server 104 described above, for example, the peripheral device 312 illustrated in FIG. 3 includes a conventional display monitor or screen 314 which may or may not include conventional touch-screen technology. Some implementations of the user computing device 112, e.g., mobile devices such as smart phones or other cellular, satellite, VOIP or other telephones, personal data assistants, tablet computers and/or other mobile devices, further include a conventional, on-board camera 316. In some embodiments, as illustrated by dashed-line representation in FIG. 3, the peripheral devices 312 may further include a near-field communication device 318 which may be used to exchange information with any similarly equipped ones of the one or more of the point-of-sale systems 110₁-110_{K}, 110₁-110_{J} as discussed above. For example, the near-field communication device 318 may be used to transfer customer information, e.g., customer identification information in the form of one or more identification codes, user names, passwords, or the like, and/or other information and/or data, from the user computing device 112 to such similarly equipped ones of the one or more of the point-of-sale systems 110₁-110_{K}, 110₁-110_{J} as further described above.

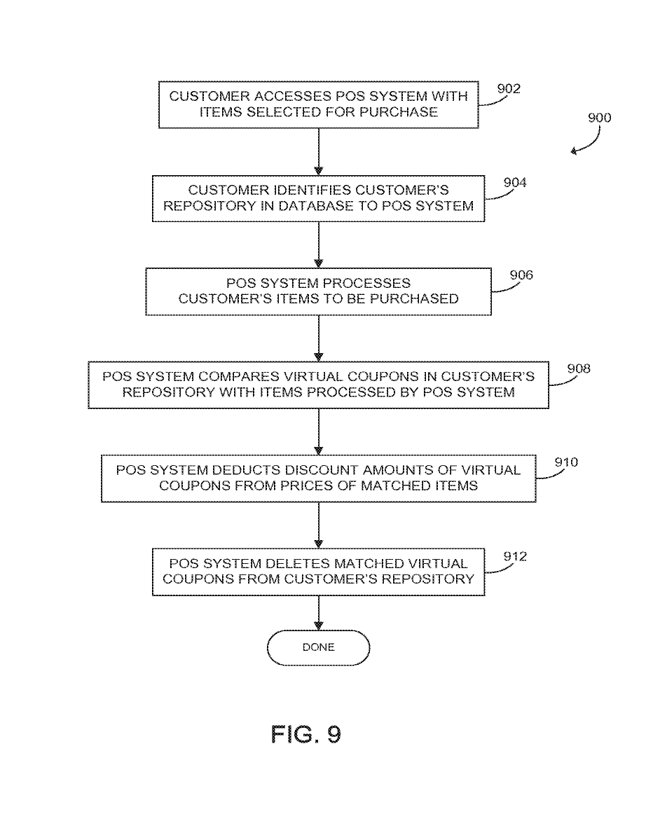

One or more customers of the business enterprise has an associated virtual customer coupon repository within a database of the main server 102, which repository which has one or more virtual coupons stored therein for use, i.e., redemption, only by that customer at any of the one or more point-of-sale systems 110₁-110_{K}, 110₁-110_{J}. Such a dedicated virtual customer coupon repository may, in some embodiments, be available to customers who join a shopping club or similar service offered by the business enterprise in which customers provide the business enterprise with certain personal identification information and which the service typically then, in turn, provides discount offers for one or more items purchasable from the business enterprise, e.g., in the form of one or more corresponding virtual coupons. In such embodiments, customers may illustratively be issued a membership card or other such token which includes one or more identification codes unique to each such card or token (and therefore unique to each customer). Such one or more unique identification codes can be entered into any of the one or more point-of-sale systems 110₁-110_{K}, 110₁-110_{J}, e.g., by scanning a barcode or magnetic strip or other such identification code-carrying structure attached to or integral with the membership card or other such token and/or by manually or otherwise entering the one or more unique identification codes into a point-of-sale system 110₁-110_{K}, 110₁-110_{J}. When any such one or more unique identification codes is entered into a point-of-sale system 110₁-110_{K}, 110₁-110_{J}, the processor 200 of the point-of-sale system 110₁-110_{K}, 110₁-110_{J} identifies the customer and associates that customer with the current purchase transaction being carried out at the point-of-sale system 110₁-110_{K}, 110₁-110_{J}. The point-of-sale system 110₁-110_{K}, 110₁-110_{J}, which is communicatively coupled to the main server 102 via a local hub server 104, 106, can then access virtual coupons resident within that customer's virtual customer coupon repository in the main server 102, and can automatically redeem each virtual coupon in the customer's virtual customer coupon repository that matches an item being purchased by the customer in the current purchase transaction, as will be described further below with respect to FIG. 9. MPERKS®, a virtual customer coupon collection and redemption program offered to customers by Meijer, Inc. of Grand Rapids, Mich., is an example of one such shopping club or similar service, although it will be appreciated that any virtual customer coupon service which makes available to customers virtual customer coupon repositories in which virtual coupons can be stored and automatically redeemed by customers during item purchase transactions at point-of-sale systems or terminals may be alternatively be used.

In any case, the one or more virtual coupons stored in the customer's virtual customer coupon repository within a database of the main server 102 may be accessed and managed by the customer via one of the user computing devices 112₁-112_{M}. In this regard, the memory 306 and/or the data storage 308 of the user computing device 112 illustratively has one or more sets of instructions stored therein that is/are executable by the processor 300 to display on the display monitor 314 the contents of the customer's virtual customer coupon repository and to allow the customer to receive, manipulate, manage and delete virtual coupons within that customer's virtual customer coupon repository.

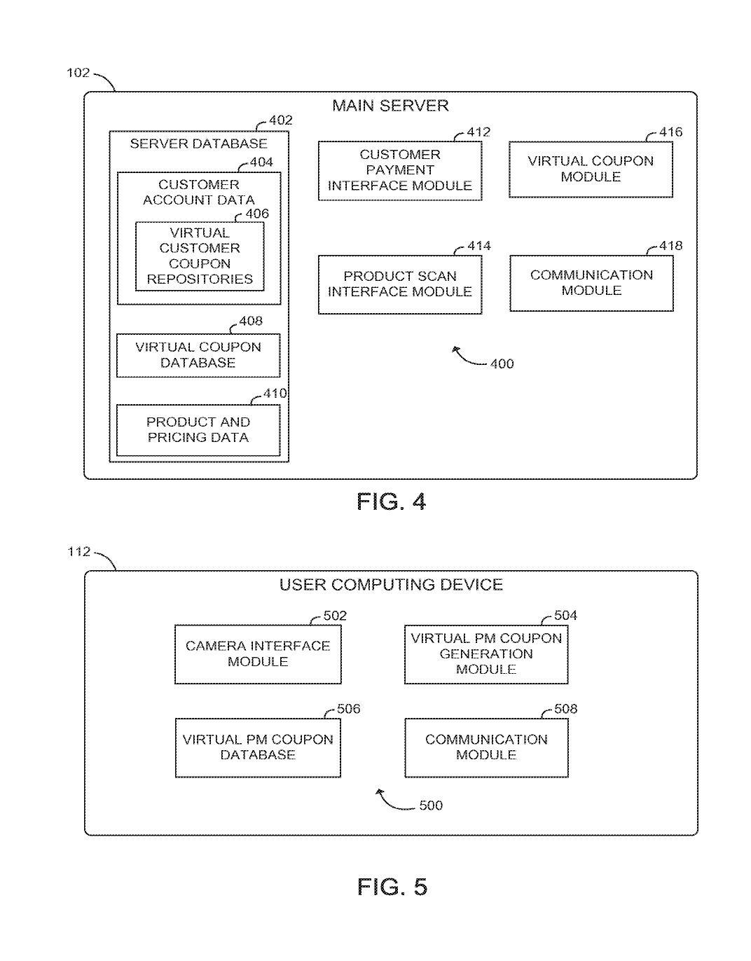

Referring now to FIG. 4, a simplified block diagram is shown of an embodiment of an environment 400 of the main server 102 illustrated in FIG. 1. In the illustrated embodiment, the environment 400 includes a server database 402 which includes customer account data 404, a virtual coupon database 408 and product and pricing data 410. The customer account data 404 has stored therein all account-related information for customers which have a customer account with the business enterprise, i.e., which have joined, and are members of, a virtual customer coupon service hosted by the business enterprise. Examples of the account-related information for each customer in the customer account data portion 404 of the server database 402 may include, but should not be limited to, customer name, customer mailing address, one or more customer e-mail addresses, one or more customer telephone or cellular telephone numbers, customer age, customer gender, customer marital status, number, gender and/or ages of family members, business units or areas of the business enterprise in which the customer regularly purchases items (e.g., grocery, pharmacy, hardware, sporting goods, fuel, etc.), virtual coupon preferences, e.g., preference(s) for discounts in one or more areas of the business enterprise, such as one or more of groceries, medical prescriptions, gasoline (or diesel fuel), hardware, sporting goods, seasonal items, etc., and the like. Additionally, the customer account data 402 includes unique customer identification information associated with each such customer account, examples of which may be or include any one or more of a personal identification number (PIN), alphanumeric code, password, user name or code or other identification data that is unique to each customer. The unique customer identification information (Customer ID) assigned to any such customer may be provided on a physical medium such as a card or other token in the form of, for example, a barcode that may be scanned at a point-of-sale system 110₁-110_{K}, 110₁-110_{J}, a magnetic strip or radio-frequency identification (RFID) tag that may be read at a point-of-sale system 110₁-110_{K}, 110₁-110_{J}, or the like. Alternatively or additionally, the Customer ID may be stored in or on an electronic device, such as a smart phone, personal data assistant, tablet computer or the like, and which may be provided to a point-of-sale system 110₁-110_{K}, 110₁-110_{J} via a suitable wireless communication mechanism, e.g., near-field communication device, radio-frequency transmitter or transceiver, or other such mechanism. Alternatively or additionally still, the Customer ID may be manually entered into a point-of-sale system 110₁-110_{K}, 110₁-110_{J} by the customer and/or by an employee of the business enterprise, e.g., a cashier, using a keyboard, keypad, touch screen, or the like, and with or without the assistance of a conventional customer lookup application.

In any case, the customer account data 404 further includes a plurality of virtual customer coupon repositories 406, i.e., a portion of the database 402 in which virtual customer coupons are stored. A separate virtual customer coupon repository is provided for each customer having a customer account with the business enterprise, i.e., each customer that has joined the virtual customer coupon service hosted by the business enterprise. Each such virtual customer coupon repository may be provided in a physically separate part or portion of the server database 402, or may alternatively be provided in a common virtual customer coupon repository in which each separate virtual customer coupon repository is maintained separately from the others such that only the business enterprise and the customer has access to that customer's virtual customer coupon repository 406. Each such virtual customer coupon repository is linked with a corresponding Customer ID such that access to any particular virtual customer coupon repository may be gained by entering a corresponding Customer ID into the main server 102. The main server 102 is configured in a conventional manner to provide such access to virtual customer coupon repositories based on Customer ID.

The virtual coupon database 408 holds virtual coupons which are provided by the main server 102 to customers, i.e., which may be selectively transferred by the main server 102 (e.g., by the processor 140) to one or more of the virtual customer coupon repositories 406. In some embodiments, customers may also add virtual coupons to their virtual customer coupon repositories 406 from other sources, although redemption by the main server 102 of any such virtual coupons from other sources will generally be subject to rules established by the business enterprise. In any case, the main server 102 may be configured in a conventional manner to selectively transfer individual virtual coupons to one or more of the virtual customer coupon repositories 406. Generally, the population of virtual coupons stored in the virtual coupon database 408 will be dynamic, and the makeup of this population at any time will typically depend on one or more factors, examples of which may include, but should not be limited to, discounts provided by manufacturers/suppliers of items offered for sale by the business enterprise, season of the year, promotional events, item inventory, targeted sales efforts, and the like.

The product and pricing data 410 portion of the server database 402 includes product identification and pricing information for items offered for sale by the business enterprise. Illustratively, the product pricing information is linked to the product identification information via scan codes such that when items are scanned for purchase, the scan code of each item will identify a particular item at a particular price in the product and pricing database 410.

The environment 400 of the main server 1012 further includes a customer payment interface module 412, a product scan interface module 414, a virtual coupon module 416 and a communication module 418. The customer payment interface module 412 is configured, in a conventional manner, to process electronic forms of customer payment, e.g., credit card, debit card, etc., used at the point-of-sale systems 110₁-110_{K}, 110₁-110_{J}. The product scan interface module 414 is configured, in a conventional manner, to link item scanning activity at the point-of-sale systems 110₁-110_{K}, 110₁-110_{J} to the product and pricing database 410 so that the point-of-sale systems 110₁-110_{K}, 110₁-110_{J} have accesses to current item identity and pricing information for items being purchased. The virtual coupon module 416 is configured to selectively transfer individual virtual coupons to one or more of the virtual customer coupon repositories. The communication module 418 is configured, in a conventional manner, to control and manage all communications between the main server 102 and the local hub servers 104, 106, between the main server 102 and the user computing devices 112₁-112_{M} and between the main server 102 and the one or more external device(s)/system(s) 160.

Referring now to FIG. 5, a simplified block diagram is shown of an embodiment of an environment 500 of an example one 112 of any of the one or more user computing devices 112₁-112_{M} illustrated in FIG. 1. In the illustrated embodiment, the environment 500 includes a camera interface module 502, a virtual print media (PM) coupon generation module 504, a virtual PM coupon database 506 and a communication module 508. The virtual PM coupon generation module 504 is configured to selectively convert one or more forms of conventional print media coupons to virtual print media (PM) coupons, as will be described in detail below. The virtual PM coupon database 506 is included in embodiments in which one or more virtual PM coupons are stored, however briefly, and/or maintained by the user computing device 112. The communication module 508 is configured, in a conventional manner, to control and manage all communications between the user computing device 112 and the main server 102, and between the user computing device 112 and the one or more external device(s)/system(s) 160.

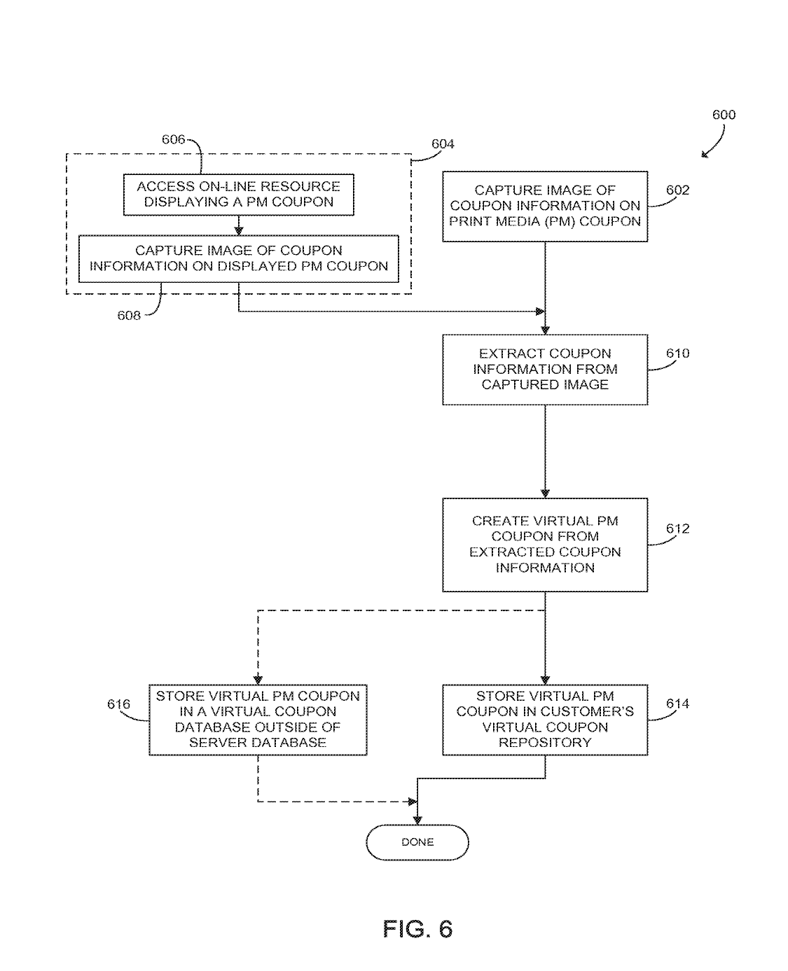

Referring now to FIG. 6, a simplified flow diagram is shown of an embodiment of a process 600 for selectively converting a print media coupon to a virtual print media coupon using one of the user computing devices 112₁-112_{M} illustrated in FIGS. 1, 3 and 5. In one embodiment, the process 600 is stored in the memory 306 and/or data storage 308 of any of the one or more user computing devices 112₁-112_{M} in the form of one or more sets of instructions executable by the processor 300. In alternative embodiments, some or all of the one or more sets of instructions may be stored in a memory and/or data storage of another device or system, such as one or more external device(s)/system(s) 160 forming part or all of a cloud computing service accessible by one or more of the user computing devices 112₁-112_{M}. In such embodiments, some or all of the one or more sets of instructions may be executed by the processor 300, and/or some or all of the one or more sets of instructions may be executed by one or more processors associated with the one or more external device(s)/system(s) 160. For purposes of this disclosure, the process 600 will be described as being executed by the processor 300 of one of the one or more user computing devices 112₁-112_{M}, although it will be understood that some or all of the process 600 may alternatively be executed by one or more processors of one or more external device(s)/system(s) 160.

In one embodiment, the process 600 illustrated in FIG. 6 provides for the storage of converted virtual PM coupons in a virtual customer coupon repository 406, within the server database 402, that is associated with a particular customer who is a member of a virtual customer coupon service hosted by a business enterprise. Hereafter in this document, the term “customer” may in some cases refer to a member of a virtual coupon service hosted by a business enterprise, and in such cases the term “customer's repository” will refer to a virtual customer coupon repository 406, or portion thereof, of the server database 402 assigned by the business entity to that customer. It will be understood that the customer will be linked to the customer's repository 406 by a unique Customer ID, as this term is defined above, and that the processor 140 of the main server 102 uses this Customer ID to accesses the customer's repository at the direction of the customer via an associated one of the user computing devices 112₁-112_{M}, at the direction of an employee of the business entity and/or pursuant (e.g., automatically) to instructions executed by the processor 140 as part of a virtual coupon offer and/or as part of an item sale/purchase transaction undertaken by the customer. The term “customer” may, in other cases, may alternatively refer to purchasers of items from the business enterprise but who may or may not be members of a virtual customer coupon service hosted by the business enterprise. The following description will endeavor to distinguish between these two different classes of customers in instances and/or examples which merit such distinction, and in so doing customers in the former category may sometimes be referred to as “member customers” and customers in the latter category may sometimes be referred to as “non-member customers.”

In any case, the process 600 begins at block 602 where the processor 300 controls the capture of an image of coupon information on or accompanying a print media coupon. In one example embodiment, the processor 300 is configured to execute block 602 by prompting and guiding the customer associated with the user computing device 112 to capture an image of the coupon information on the print media coupon by selectively operating the camera 318 to capture a photograph of the coupon information on the print media coupon.

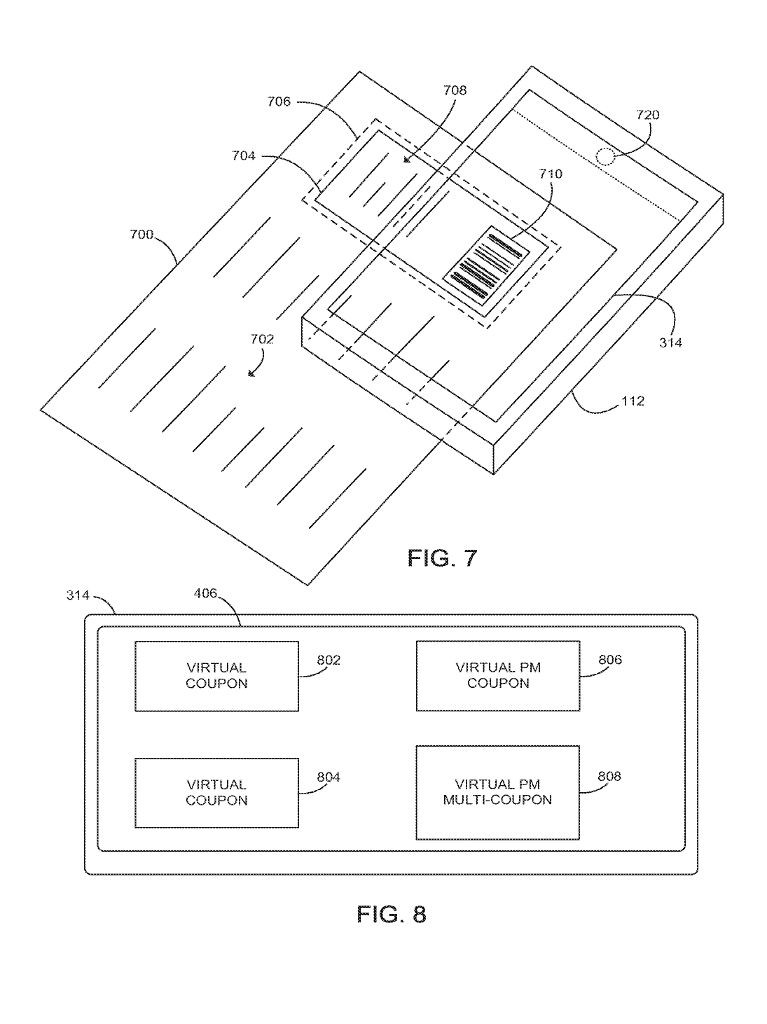

Referring to FIG. 7, a graphic example of this embodiment of the process block 602 is shown. In the illustrated example, a page 700 of a print media example is shown, e.g., a magazine or newspaper, which illustratively includes some text 702 and a print media coupon 704. The print media coupon 704 is outlined 706 in a conventional manner to illustrate cut lines for removing the print media coupon 704 from the page 700. The illustrated print media coupon 704 includes text 708, and may further include one or more graphic images (not shown). The print media coupon 704 further includes coupon information 710, e.g., in the form of a conventional barcode, such as a conventional GS1 barcode, although other barcode forms and/or other forms of the coupon information 710 are contemplated. In embodiments in which the coupon information 710 is a conventional GS1 barcode, i.e., a conventional data bar that uses a conventional, so-called GS1 identification system, the coupon information 710 in the databar portion illustratively includes an application identifier, a company prefix, an offer code, a primary purchase family code, a primary purchase requirement and a save (item discount) value, and may further include a primary purchase requirement, a second company prefix and a second family code. Alternatively to, or in addition to, the GS1 barcode, the coupon information 710 may include one or more other conventional barcodes to enable and/or facilitate scanning of items at one of the point-of-sale systems 110₁-110_{K}, 110₁-110_{J}, and examples of such one or more other conventional barcodes include, but are not limited to, one or more UPC barcodes, or more EAN barcodes, or the like. In any case, the camera 318 of the user computing device 112 is positioned over the coupon information 710 of the print media coupon 704, as shown in FIG. 7, such the coupon information 710 of the print media coupon 704 is displayed via the camera 318 on the display screen 314 of the user computing device 112. In the illustrated embodiment, the processor 300 is configured to display a camera activation graphic 720 that is part of the conventional camera interface module 502, and the customer associated with the user computing device 112 is prompted at block 602 of the process 600 to capture an image of the coupon information 710. It will be appreciated that while the print media 700 is illustrated in FIG. 7 in the form of a magazine or newspaper, the print media 700 may alternatively be any print media, as this term is defined above, which displays coupon information 710 capable of image capture by the camera 318 of the user computing device 112 with sufficient resolution to allow the processor 300 to ascertain the coupon information 710.

Referring again to FIG. 6, the process 600 may, in addition to or alternatively to the process block 602, include another process block 604 as shown by dashed-line representation in FIG. 6. In embodiments which include the process block 604, an image of a print media coupon displayed on an on-line resource, e.g., an internet website, may be captured. In the illustrated embodiment, the process block 604 includes a process block 606 at which the processor 300 is operable, under the direction of the customer associated with the user computing device 112, to access an on-line resource displaying a print media coupon. Generally, the on-line resource may be any internet website or other resource accessible by the user computing device 112 via the network 114 which includes a displayable form of one or more print media coupons, as the term “print media coupon” is defined above. Following step 606, the processor 300 is operable at step 608 to capture an image of the coupon information displayed on the print media coupon. In one embodiment, the processor 300 is configured to execute step 608 by prompting and guiding the customer associated with the user computing device 112 to capture an image of the coupon information on the displayed print media coupon by selectively operating the camera 318 to capture a photograph of the coupon information on the print media coupon as described above with respect to the process block 602. Alternatively or additionally, the processor 300 may be operable to execute the process block 608 by capturing, in a conventional manner, a link or tag associated with the displayed print media coupon.

The process 600 advances from either, or both, of the process blocks 602 and 604 to a process block 610 where the processor 300 extracts the coupon information from the coupon information image captured at block 602 and/or at block 604. Using the example illustrated in FIG. 7, the processor 300 is illustratively operable at the process block 610 to extract the coupon information by extracting the barcode and/or by extracting coupon information carried by such a barcode. Thereafter at process block 612, the processor 300 creates a virtual print media (PM) coupon from the extracted coupon information. In embodiments in which the extracted information is the form of a product barcode, such as a GS1, UPC and/or EAC barcode, the processor 300 may illustratively execute the process block 612 simply by retaining, e.g., storing in working memory, the extracted barcode. In other embodiments, the processor 300 may execute the process block 612 by decoding the extracted coupon information and constructing in working memory a code or sequence of codes based on the extracted coupon information. In still other embodiments, the processor 300 may execute the process block 612 by decoding the extracted coupon information and constructing in working memory one or more information fields each containing different data extracted from the coupon information, e.g., a field containing a company identifier, another field containing an offer, e.g., discount, amount, another field containing primary purchase family information, etc. In any case, the processor 300 may be further operable at step 612 to create and/or import one or more graphic symbols and/or one or more text description(s) identifying the product(s) associated with the virtual PM coupon, and to include such graphic symbols and/or text in or with the virtual PM coupon.

Following the process block 612, one embodiment of the process 600 advances to step 614 where the processor 300 stores the virtual PM coupon created at process block 612 in the customer's virtual coupon repository 406 in the database 402 of the main server 402. In one embodiment, the process block 614 may, at least for the first execution thereof, require the customer to enter identification information relating to the customer's virtual coupon repository 406, e.g., user name and/or password, customer identification code, or the like. In other embodiments, the process 600 may link directly with, or form part of, a customer virtual coupon repository management application resident on the user computing device 112, and in such embodiments the processor 300 will have access to the customer identification, and such customer identification information therefore need not be supplied by the customer. In any case, the processor 300 is operable as just described in some embodiments to store a virtual PM coupon, created at the process block 612, in the customer's virtual coupon repository 406 separately from any other virtual coupon or virtual PM coupon stored therein. Alternatively or additionally, the processor 300 may be operable at process block 614 to store a virtual PM coupon in the customer's virtual coupon repository 406 by merging the virtual PM coupon with one or more pre-existing virtual coupons and/or virtual PM coupons to thereby create a virtual PM multi-coupon. In embodiments in which the coupon information is provided in the form of a GS1 or other conventional barcode, for example, known barcode data merging techniques may be used to merge the coupon information of a plurality of virtual PM coupons, and/or one or more other virtual coupons previously stored in the customer's virtual coupon repository 406, into a single, virtual PM multi-coupon.

Referring now to FIG. 8, a simplified block diagram is shown illustrating the contents of one example virtual customer coupon repository 406 displayed on the display screen 314 of the user computing device 112 under control of the customer. In the illustrated embodiment, the virtual customer coupon repository 406 contains two virtual coupons 802 and 804 previously added by the main server 102 and/or by the customer. In addition to the virtual coupons 802 and 804, the virtual customer coupon repository 406 further includes a virtual print media (PM) coupon 806 added by the customer to the customer's virtual customer coupon repository 406 using the process 600 illustrated in FIG. 6. The illustrated virtual coupon repository 406 further contains a virtual PM multi-coupon 808 added by the customer and the processor 300 as described above.

Referring again to FIG. 6, the process 600 may alternatively or additionally advance from the process block 612 to the process block 616 as shown by dashed-line connection. In embodiments that include the process block 616, the processor 300 is operable to store the virtual PM coupon, created at the process block 612, in a virtual coupon database that is separate from, i.e., outside of, the virtual coupon repository 406 of the server database 402 of the main server 102. In one embodiment, for example, the separate or outside database is the virtual PM coupon database 506 on-board the user computing device 112. In alternative embodiments, the separate or outside database may be one or more databases associated with one or external devices or systems 160, in which case the user computing device 112 may access such one or more databases via the network 114 to store virtual PM coupons in, and retrieve virtual PM coupons from, such one or more databases. In still other embodiments, the separate or outside database may be one associated with another user computing device 112 owned by or under the control of the customer, in which case the customer may stored virtual PM coupons in such a separate or outside database by transferring virtual PM coupons to such other user computing device 112, e.g., via e-mail, mobile messaging service, or other wireless mechanism, or via a portable memory device. In any case, the process block 616 may be included in embodiments in which it may be desirable to carry one or more virtual PM coupons on a mobile user computing device 112, and/or to make one or more virtual PM coupons otherwise accessible by a mobile user computing device 112, for the purpose of scanning such one or more virtual PM coupons displayed on the user computing device 112 at a point-of-sale system for redemption thereof.

As described briefly hereinabove, the processor 140 of the main server 102 illustratively executes a process which automatically redeems a virtual coupon resident in a customer's repository 406 when a customer purchases one or more items that match the virtual coupon. If the customer's repository 406 alternatively or additionally includes one or more virtual PM coupons, such a process executed by the processor 140 of the main server 102 treats any such virtual PM coupons contained within the customer's repository 406 identically and therefore automatically redeems virtual PM coupons resident in the customer's repository 406 when the customer purchases one or more items that match the virtual PM coupon. Referring now to FIG. 9, a simplified flow diagram is shown of at least one embodiment of such a process 900 for automatically or selectively redeeming of one or more such virtual PM coupons as customers purchase one or more corresponding items at a point-of-sale system 110₁-110_{K}, 110₁-110_{J} and for offering the customer an option to store any such virtual PM coupons in the customer's repository 406. As used in the process 900 illustrated in FIG. 9, the one or more virtual coupons may include one or more virtual coupons placed in the customer's repository 406 by the business enterprise in accordance with one or more so-called “digital offers,” e.g., monetary rewards offered by the business enterprise in the form of virtual coupons and placed by the business enterprise into one or more customer repositories 406, and/or one or more virtual print media (PM) coupons, as this term is defined above. In one embodiment, some parts of the illustrated process 900 are carried out by a customer and other parts are stored in the memory 206 and/or data storage 208 of a point-of-sale system 110₁-110_{K} in the form of one or more sets of instructions executable by the processor 200, and still other parts are stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106. For purposes of this disclosure, some process blocks of the process 900 will be described as being executed by the processor 140 of the main server 102 and others will be described as being executed by the processor 200 of a point-of-sale system 110₁-110_{K}, 110₁-110_{J}, although it will be understood that some or all of the process 900 may alternatively be executed by a processor 120 of a local hub server 104, 106.

The process 900 begins at a process block 902 where the customer accesses a point-of-sale system 110₁-110_{K}, 110₁-110_{J} with one or more selected items for purchase, e.g., resulting from a shopping expedition at an retail outlet of the business enterprise. Thereafter at a process block 904, the customer identifies that customer's repository in the server database 402 to the processor 200 of the point-of-sale system 110₁-110_{K}, 110₁-110_{J}. In one embodiment, as described in detail above, the process block 904 may be executed by providing the customer's Customer ID to the processor 200 of the point-of-sale system 110₁-110_{K}, 110₁-110_{J}, and the processor 200 of the point-of-sale system 110₁-110_{K}, 110₁-110_{J} is operable to transfer the obtained Customer ID to the main server 102. Thereafter at a process block 906, the processor 200 of the point-of-sale system 110₁-110_{K}, 110₁-110_{J} processes, e.g., price scans, each of the one or more items selected for purchase by the customer. Thereafter at a process block 908, the processor 200 compares the virtual coupons in the customer's repository with each of the items selected for purchase by the customer and scanned by the point-of-sale system 110₁-110_{K}, 110₁-110_{J}. The virtual coupons referred to at the process block 908 may include one or more virtual coupons placed in the customer's repository 406 by the business enterprise in accordance with one or more so-called “digital offers,” e.g., monetary rewards offered by the business enterprise in the form of virtual coupons and placed by the business enterprise into one or more customer repositories 406, and/or one or more virtual print media (PM) coupons, as this term is defined above.

Following the process block 908, the process 900 advances to a process block 910 where the processor 200 deducts the discount amounts of all such virtual coupons from the prices of the matched item(s). In one embodiment, execution of the process block 910 is automatic, e.g., automatically executed by the processor 200. In alternate embodiments, the process block 910 may be configured in a conventional manner to be selective such that execution of the process block 910 requires customer approval with respect to all of the virtual coupons stored in the customer's virtual coupon repository or with respect to each of the virtual coupons stored in the customer's virtual coupon repository. Thereafter at the process block 912, the processor 140 or the processor 200, in one embodiment of the process 900, deletes any such matched virtual coupons from the customer's repository 406. In alternate embodiments, the processor 140 or the processor 200 may, at the process block 912, delete from the customer's repository 406 only virtual coupons placed in the customer's repository 406 by the business enterprise in accordance with one or more so-called “digital offers,” and leave any virtual PM coupons in the customer's repository for future redemption at and by a point-of-sale system 110₁-110_{K}, 110₁-110_{J}. In any case, the process 900 advances from the process block 912 to DONE.

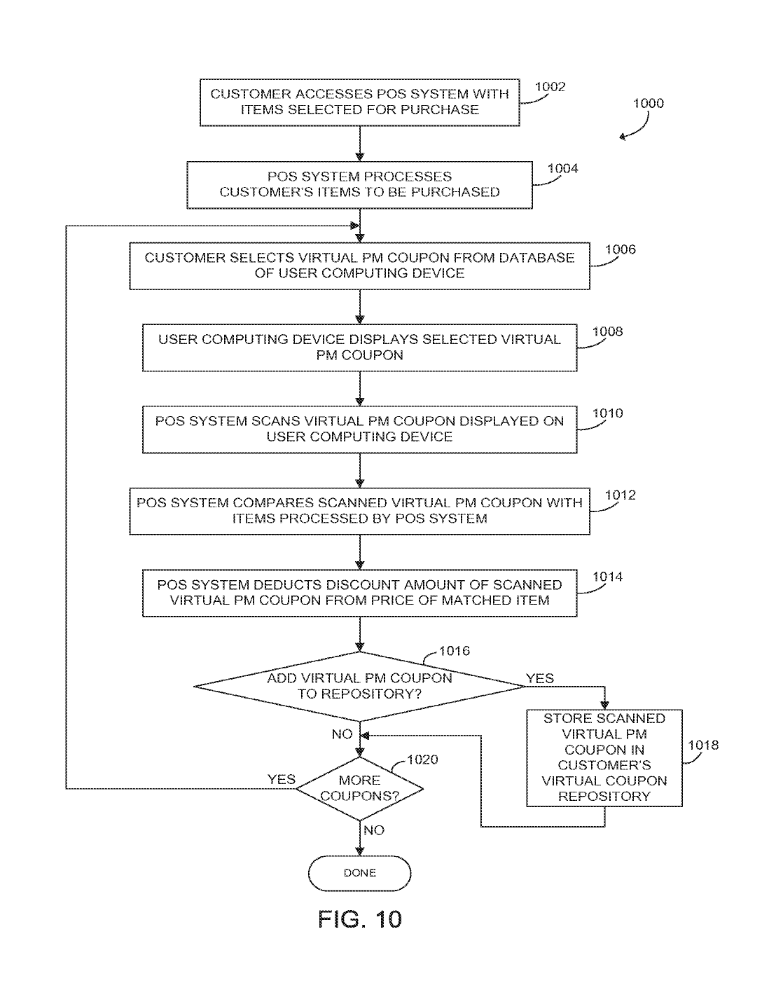

As briefly described above, this disclosure contemplates embodiments in which one or more virtual PM coupons is/are stored in a virtual PM coupon database 506 on-board a mobile user computing device 112, and/or in an external database that is separate from the mobile user computing device and from the main server 102 but accessible by the user computing device 112 via the network 114. In any such embodiments, the customer may control the user computing device 112 to display one or more stored virtual PM coupons, and the point-of-sale system 110₁-110_{K}, 110₁-110_{J} may then scan and automatically redeem any such displayed virtual PM coupon directly from the display 314 of the user computing device 112. The main server 102 may then present the customer with an option to add the scanned virtual PM coupon to the customer's repository 406. Referring now to FIG. 10, a simplified flow diagram is shown of at least one embodiment of such a process 1000 for scanning one or more virtual PM coupons displayed on a mobile user computing device 112 and automatically redeeming such one or more such virtual PM coupons as customers purchase one or more corresponding items at a point-of-sale system 110₁-110_{K}, 110₁-110_{J}. In one embodiment, some parts of the illustrated process 1000 are carried out by a customer and other parts are stored in the memory 206 and/or data storage 208 of a point-of-sale system 110₁-110_{K} in the form of one or more sets of instructions executable by the processor 200, and still other parts are stored in the memory 146 and/or data storage 148 of the main server 102 in the form of one or more sets of instructions executable by the processor 140 and still further parts are stored in the memory 306 and/or data storage 308 and/or memory of an external device/system 160 executable by the processor 300 and/or processor(s) of the external device/system 160. In alternative embodiments, some or all of the one or more sets of instructions may be stored in a memory and/or data storage of a local hub server 104, 106 and executed by a processor 120 of the local hub server 104, 106. For purposes of this disclosure, some process blocks of the process 1000 will be described as being executed by the processor 140 of the main server 102, others will be described as being executed by the processor 200 of a point-of-sale system 110₁-110_{K}, 110₁-110_{J} and still others will be described as being executed by the processor 300 of user computing device 112₁-112_{M} (and/or one or more processors of one or more external/device(s)/system(s)) although it will be understood that some or all of the process 1000 may alternatively be executed by a processor 120 of a local hub server 104, 106.

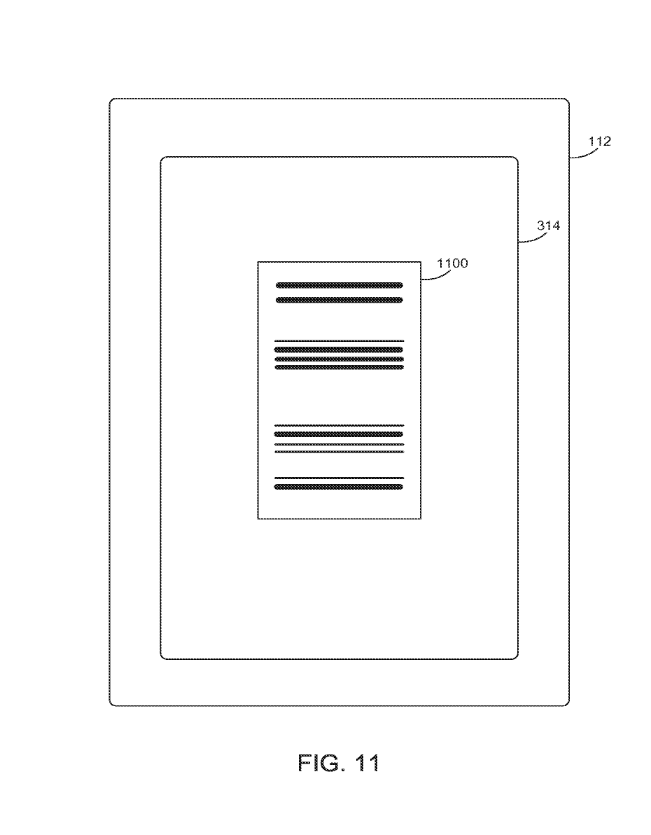

The process 1000 begins at a process block 1002 where the customer accesses a point-of-sale system 110₁-110_{K}, 110₁-110_{J} with one or more items selected for purchase, e.g., resulting from a shopping expedition at an retail outlet of the business enterprise. Thereafter at a process block 1004, the processor 200 of the point-of-sale system 110₁-110_{K}, 110₁-110_{J} processes, e.g., price scans, each of the one or more items selected for purchase by the customer. Thereafter at a process block 1006, the customer controls the customer's mobile user computing device 112 to select a virtual PM coupon from the database 506 of the mobile user computing device 112 (or from a database of one or more external device(s)/system(s) 160. Thereafter at a process block 1008, the processor 300 of the mobile user computing device 112 controls the display monitor 318 of the mobile user computing device to display an image of the virtual PM coupon. In one embodiment, the image of the virtual PM coupon includes only the coupon information portion of the print media coupon, e.g., only the barcode of the print media coupon. This embodiment is illustrated in FIG. 11 in which an example barcode 1100 of a virtual PM coupon is displayed on the display monitor 314 of a mobile user computing device 112. In alternative embodiments, the displayed virtual PM coupon may include alternate or additional information, and/or one or more alternate or additional barcodes. In still other alternative embodiments, any such displayed virtual PM coupon may be or include a virtual PM multi-coupon as described above. In any case, the process 1000 of FIG. 10 advances from the process block 1008 to a process block 1010 where the processor 200 of the point-of-sale system 110₁-110_{K}, 110₁-110_{J} scans, e.g., via one of the item scanners 216, the virtual PM coupon displayed on the display monitor 314 of the customer's mobile user computing device 112.

Following the process block 1010, the process 1000 advances to a process block 1012 where the processor 200 of the point-of-sale system 110₁-110_{K}, 110₁-110_{J} compares the scanned virtual PM coupon with the items processed by the point-of-sale system 110₁-110_{K}, 110₁-110_{J}, i.e., items selected for purchase by the customer and scanned by the point-of-sale system 110₁-110_{K}, 110₁-110_{J}. Thereafter at the process block 1014, the processor 200 of the point-of-sale system 110₁-110_{K}, 110₁-110_{J} deducts the discount amount of the scanned virtual PM coupon from the price of any matched item(s) found during execution of the process block 1012. In one embodiment, execution of the process block 1014 is automatic, e.g., automatically executed by the processor 200. In alternate embodiments, the process block 1014 may be configured in a conventional manner to be selective such that execution of the process block 1014 requires customer approval with respect to all of the virtual coupons stored in the customer's virtual coupon repository or with respect to each of the virtual coupons stored in the customer's virtual coupon repository. Thereafter in one embodiment of a process block 1016, the processor 200 prompts the customer to select, e.g., via a suitable key or graphic displayed on one of a customer payment interface 214, whether to add the virtual PM coupon just scanned to the customer's repository 406. If the customer so selects, the process 1000 advances to a process block 1018 where the processor 140 of the main server 102 stores the scanned virtual PM coupon in the customer's virtual coupon repository 406. Alternatively, the process blocks 1016 and 1018 may be configured such that the processor 140 of the main server 102 automatically adds the virtual PM coupon just scanned to the customer's virtual coupon repository 406. Following the illustrated process block 1018, and following the illustrated process block 1016 when the customer elects not to add the virtual PM coupon to that customer's repository 406, the process 1000 advances to a process block 1020 where the processor 200 of the point-of-sale system 110₁-110_{K}, 110₁-110_{J} prompts the customer to produce another virtual PM coupon for scanning. If the customer produces another such virtual PM coupon for scanning, the process 1000 loops back to step 1006, and otherwise the process 1000 advances to DONE.

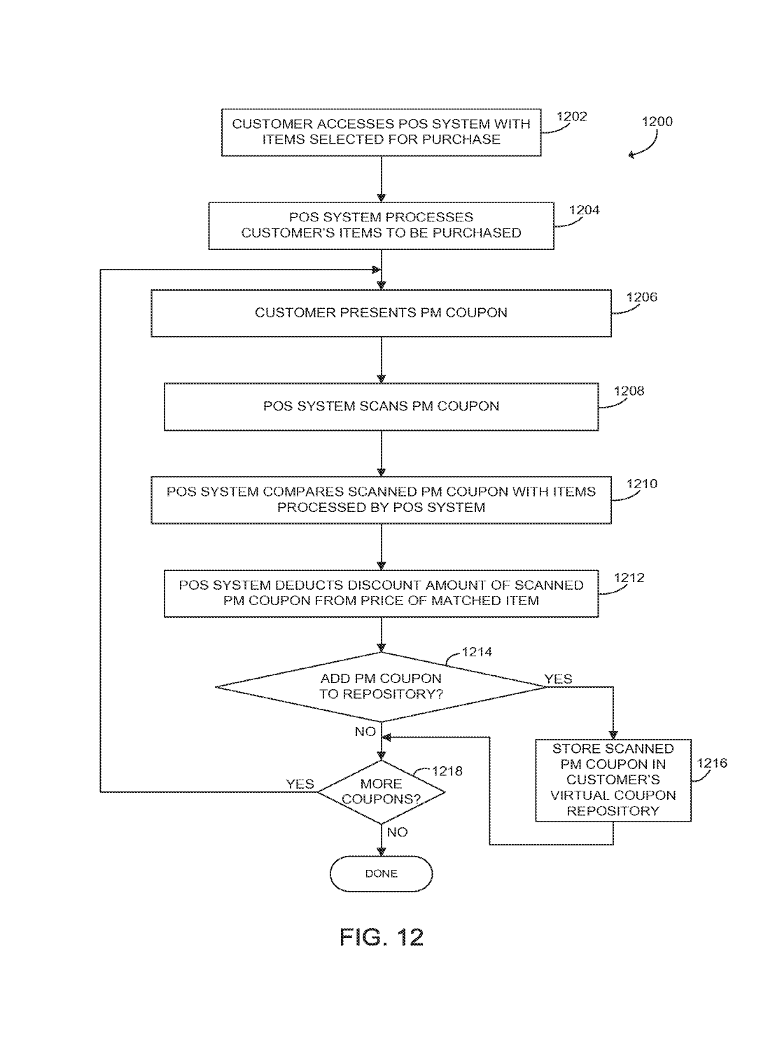

As further briefly described above, this disclosure contemplates embodiments in which the customer may present one or more conventional print media coupons for scanning by a point-of-sale system 110₁-110_{K}, 110₁-110_{J}, and the main server 102 may then present the customer with an option to add the scanned print media coupon to the customer's repository 406. Referring now to FIG. 12, a simplified flow diagram is shown of at least one embodiment of such a process 1200 for scanning one or more conventional print media coupons and automatically redeeming such one or more such print media coupons as customers purchase one or more corresponding items at a point-of-sale system 110₁-110_{K}, 110₁-110_{J}, and then storing, at the customer's option, any such scanned print media coupons in the customer's repository 406 in the form of virtual print media (PM) coupons. In one embodiment, some parts of the illustrated process 1200 are carried out by a customer and other parts are stored in the memory 206 and/or data storage 208 of a point-of-sale system 110₁-110_{K} in the form of one or more sets of instructions executable by the processor 200, and still other parts are stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106. For purposes of this disclosure, some process blocks of the process 1200 will be described as being executed by the processor 140 of the main server 102, others will be described as being executed by the processor 200 of a point-of-sale system 110₁-110_{K}, 110₁-110_{J} and still others will be described as being executed by the processor 300 of user computing device 112₁-112_{M} (and/or one or more processors of one or more external/device(s)/system(s)) although it will be understood that some or all of the process 1200 may alternatively be executed by a processor 120 of a local hub server 104, 106.

The process 1200 begins at a process block 1202 where the customer accesses a point-of-sale system 110₁-110_{K}, 110₁-110_{J} with one or more items selected for purchase, e.g., resulting from a shopping expedition at an retail outlet of the business enterprise. Thereafter at a process block 1204, the processor 200 of the point-of-sale system 110₁-110_{K}, 110₁-110_{J} processes, e.g., price scans, each of the one or more items selected for purchase by the customer. Thereafter at a process block 1206, the customer presents a conventional print media (PM) coupon, e.g., a paper coupon, to a cashier at the point-of-sale system 110₁-110_{K}, 110₁-110_{J} or directly to the point-of-sale system 110₁-110_{K}, 110₁-110_{J} in embodiments in which the point-of-sale system 110₁-110_{K}, 110₁-110_{J} is a so-called self-checkout system. Following the process block 1206, the process 1200 advances to a process block 1208 where the processor 200 of the point-of-sale system 110₁-110_{K}, 110₁-110_{J} scans, e.g., via one of the item scanners 216, the conventional PM coupon.

Following the process block 1208, the process 1200 advances to a process block 1210 where the processor 200 of the point-of-sale system 110₁-110_{K}, 110₁-110_{J} compares the scanned PM coupon with the items processed by the point-of-sale system 110₁-110_{K}, 110₁-110_{J}, i.e., items selected for purchase by the customer and scanned by the point-of-sale system 110₁-110_{K}, 110₁-110_{J}. Thereafter at the process block 1212, the processor 200 of the point-of-sale system 110₁-110_{K}, 110₁-110_{J} deducts the discount amount of the scanned PM coupon from the price of any matched item(s) found during execution of the process block 1210. Thereafter in one embodiment of a process block 1214, the processor 200 prompts the customer to select, e.g., via a suitable key or graphic displayed on one of a customer payment interface 214, whether to add the PM coupon just scanned to the customer's repository 406. If the customer so selects, the process 1200 advances to a process block 1216 where the processor 140 of the main server 102 stores the scanned PM coupon, i.e., a virtual representation of the PM coupon, in the customer's virtual coupon repository 406 in the form of a virtual PM coupon. In alternative embodiments, the process blocks 1214 and 1216 may be configured such that the processor 140 of the main server 102 automatically adds the scanned PM coupon to the customer's virtual coupon repository 406. Following the illustrated process block 1216, and following the illustrated process block 1214 when the customer elects not to add the scanned PM coupon to that customer's repository 406, the process 1200 advances to a process block 1218 where the processor 200 of the point-of-sale system 110₁-110_{K}, 110₁-110_{J} prompts the customer to produce another conventional PM coupon for scanning. If the customer produces another such conventional PM coupon for scanning, the process 1200 loops back to step 1206, and otherwise the process 1200 advances to DONE.

It should now be apparent that this disclosure is directed to methods, devices and systems for converting print media coupons to virtual print media (PM) coupons, and also to methods, devices and systems for redeeming such converted virtual PM coupons. In some embodiments, such virtual PM coupons are stored in the virtual customer coupon repositories 406 within the server database 402 of the main server 102, and can be automatically or selectively redeemed at and by a point-of-sale system 110₁-110_{K}, 110₁-110_{J} of a retail enterprise. In such embodiments, this disclosure describes four processes for converting a conventional print media coupon to a virtual PM coupon and then storing the virtual PM coupon in a customer's virtual coupon repository 406 for automatic or selective redemption at and by a point-of-sale system 110₁-110_{K}, 110₁-110_{J}. In a first example, the process 600 illustrated in FIG. provides for the capture by a customer of an image of coupon information on a conventional print media coupon using a user computing device 112₁-112_{M}, e.g., equipped with a camera, processing the captured image using the user computing device 112₁-112_{M} to create a virtual PM coupon, and then storing the virtual PM coupon in the customer's virtual coupon repository 406 for subsequent automatic or selective redemption at and by a point-of-sale system 110₁-110_{K}, 110₁-110_{J}, e.g., using the process 900 illustrated in FIG. 9. In a second example, the process 600 provides for the capture of an image or other representation of a conventional print media coupon included in content displayed by a website or other on-line resource hosted by an external device/system 106 and accessible by a user computing device 112₁-112_{M} via the network 114, processing the captured image using the user computing device 112₁-112_{M} to create a virtual PM coupon, and then storing the virtual PM coupon in the customer's virtual coupon repository 406 for subsequent automatic or selective redemption at and by a point-of-sale system 110₁-110_{K}, 110₁-110_{J}, e.g., using the process illustrated in FIG. 9. In a third example, the process 1000 illustrated in FIG. 10 provides for the scanning by a point-of-sale system 110₁-110_{K}, 110₁-110_{J} of a virtual PM coupon displayed on a mobile user computing device 112₁-112_{M}, automatically or selectively redeeming the scanned virtual PM coupon at and by a point-of-sale system 110₁-110_{K}, 110₁-110_{J}, and then automatically or selectively adding the scanned virtual PM coupon to the customer's virtual coupon repository by the main server 102 for future automatic or selective redemption at and by a point-of-sale system 110₁-110_{K}, 110₁-110_{J}, e.g., using the process illustrated in FIG. 9. In a fourth example, the process 1200 illustrated in FIG. 12 provides for the scanning by a point-of-sale system 110₁-110_{K}, 110₁-110_{J} of a conventional PM coupon, e.g., a paper coupon, automatically or selectively redeeming the scanned conventional PM coupon at and by a point-of-sale system 110₁-110_{K}, 110₁-110_{J}, and then automatically or selectively adding the scanned conventional PM coupon to the customer's virtual coupon repository by the main server 102 for future automatic or selective redemption at and by a point-of-sale system 110₁-110_{K}, 110₁-110_{J}, e.g., using the process illustrated in FIG. 9. It will be appreciated that each of these processes can be used separately or in combination. It will be further appreciated that these example processes are provided only by way of example, and should not be considered to be limiting in any way.

In other embodiments, such virtual PM coupons can be stored on a mobile user computing device 112₁-112_{M}, or on a device/system 106 accessible by a mobile user computing device 112₁-112_{M} via a network 114, and any such virtual PM coupon can be redeemed at and by a point-of-sale system 110₁-110_{K}, 110₁-110_{J} by controlling the mobile user computing device 112₁-112_{M} to display an image of the virtual PM coupon and then scanning the displayed image using an item scanner 216 of the point-of-sale system 110₁-110_{K}, 110₁-110_{J}. The process 600 illustrated in FIG. 6 provides for two separate or combinable processes for converting conventional print media coupons to virtual PM coupons using a user computing device 112₁-112_{M}, and storing such virtual PM coupons in a memory on-board or external to, but accessible by, the user computing device 112₁-112_{M} for subsequent display, scanning and redemption at and by a point-of-sale system 110₁-110_{K}, 110₁-110_{J}. As with the above examples, it will be appreciated that these example processes are provided only by way of example, and should not be considered to be limiting in any way.

It will be understood that any single feature of any embodiment illustrated and described herein may be implemented in any of the other embodiments regardless of whether or not explicitly described with respect to that embodiment. It will be further understood that not every feature described with respect to one embodiment need be implemented with that embodiment, as some features may be optional regardless of whether explicitly stated in the above description.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, while the concepts illustrated and described herein have been illustrated and described in the context of purchasing items at a point-of-sale system that is physically located at a retail outlet of the business enterprise, it will be understood that virtual PM coupons of any type and/or configuration described herein may alternatively or additionally be redeemed at a website of the business enterprise as part of an on-line purchase transaction.

What is claimed is:

1. A system for redeeming print media coupons at a retail enterprise, the system comprising:
a database having stored therein a plurality of virtual coupon repositories and a plurality of customer accounts each for a different customer member of a coupon service hosted by the retail enterprise, each customer account including a customer identifier identifying the customer associated with that customer account and linked to one of the plurality of virtual coupon associated only with that customer,
communication circuitry to send and receive wireless communication signals,
a point-of-sale terminal,
a processor communicatively coupled to the database, the communication circuitry and the point-of-sale terminal, and
a memory having instructions stored therein which, when executed by the processor, cause the processor to wirelessly receive, via the communication circuitry, a signal wirelessly transmitted from a customer mobile device and carrying information relating to an image of a print media coupon captured by a camera on-board the customer mobile device and to a specified one of the plurality of virtual coupon repositories, to process the wirelessly received information to determine therefrom a corresponding virtual print media coupon, to store the virtual print media coupon in the specified one of the plurality of virtual coupon repositories, to receive, via the point-of-sale terminal in response to customer interaction therewith as part of a transaction for the purchase of one or more items from the retail enterprise, the customer identifier associated in the database with the specified one of the plurality of virtual coupon repositories, to process, via the point-of-sale terminal, the one or more items in the purchase transaction, to compare the one or more items in the purchase transaction with the virtual print media coupon stored in the specified one of the plurality of virtual coupon repositories, and to deduct, via the point-of-sale terminal, a discount amount of the stored virtual print media coupon from a price of any item in the purchase transaction that matches the stored virtual print media coupon.

2. The system of claim 1, wherein the instructions stored in the memory further include instructions which, when executed by the processor, cause the processor to delete the virtual print media coupon from the specified one of the plurality of virtual coupon repositories following deduction of the discount amount thereof from a matching one of the items processed by the point-of-sale terminal.

3. The system of claim 1, wherein the print media coupon is printed on a tangible medium.

4. The system of claim 1, wherein the print media coupon is displayed on a display of an electronic device as an image of the print media coupon.

5. The system of claim 1, wherein the information relating to an image of the print media coupon is the virtual print media coupon created by the customer mobile communication device from the image of the print media coupon,
and wherein the instructions stored in the memory further include instructions which, when executed by the processor, cause the processor to process the wirelessly received information to determine therefrom the corresponding virtual print media coupon by extracting the received virtual print media coupon from the wirelessly received signal.

6. The system of claim 1, wherein the information relating to an image of the print media coupon is the image of the print media coupon,
and wherein the instructions stored in the memory further include instructions which, when executed by the processor, cause the processor to process the wirelessly received information to determine therefrom the corresponding virtual print media coupon by extracting coupon information from the wirelessly received image and creating the virtual print media coupon from the extracted coupon information.

7. The system of claim 1, wherein the database, the communication circuitry, the processor and the memory are part of a retail enterprise server managed and operated by the retail enterprise.

8. The system of claim 1, wherein the point-of-sale terminal is separate from but communicatively coupled to the retail enterprise server.

9. A method of redeeming print media coupons at a retail enterprise, the method comprising:
wirelessly receiving, via communication circuitry communicatively coupled to a processor, a signal wirelessly transmitted from a customer mobile device and carrying information relating to an image of a print media coupon captured by a camera on-board the customer mobile device and to a specified one of a plurality of virtual coupon repositories stored in a database also communicatively coupled to the processor, the database further having stored therein a plurality of customer accounts each for a different customer member of a coupon service hosted by the retail enterprise, with each customer account including a customer identifier identifying the customer associated with that customer account and linked to one of the plurality of virtual coupon associated only with that customer,
processing, by the processor, the wirelessly received information to determine therefrom a corresponding virtual print media coupon,
storing, by the processor, the virtual print media coupon in the specified one of the plurality of virtual coupon repositories,
receiving, via a point-of-sale terminal communicatively coupled to the processor, in response to customer interaction therewith as part of a transaction for the purchase of one or more items from the retail enterprise, the customer identifier associated in the database with the specified one of the plurality of virtual coupon repositories,
processing, via at least one of the processor and the point-of-sale terminal, the one or more items in the purchase transaction,
comparing the one or more items in the purchase transaction with the virtual print media coupon stored in the specified one of the plurality of virtual coupon repositories, and
deducting, via at least one of the processor and the point-of-sale terminal, a discount amount of the stored virtual print media coupon from a price of any item in the purchase transaction that matches the stored virtual print media coupon.

10. The method of claim 9, further comprising deleting the virtual print media coupon from the specified one of the plurality of virtual coupon repositories following deduction of the discount amount thereof from a matching one of the items processed by the point-of-sale terminal.

11. The method of claim 9, wherein the image of the print media coupon is captured by the camera on-board the customer mobile device from a print media coupon printed on a tangible medium.

12. The method of claim 9, wherein the image of the print media coupon is captured by the camera on-board the customer mobile device from an image of the print media coupon displayed on a display of an electronic device.

13. The method of claim 9, wherein the information relating to an image of the print media coupon is the virtual print media coupon created by the customer mobile communication device from the image of the print media coupon,
and wherein processing the wirelessly received information to determine therefrom the corresponding virtual print media coupon comprises extracting the received virtual print media coupon from the wirelessly received signal.

14. The method of claim 9, wherein the information relating to an image of the print media coupon is the image of the print media coupon,
and wherein processing the wirelessly received information to determine therefrom the corresponding virtual print media coupon comprises extracting coupon information from the wirelessly received image and creating the virtual print media coupon from the extracted coupon information.

15. A non-transitory machine-readable medium comprising a plurality of instructions which, when executed by at least one processor, result in the at least one processor:
wirelessly receiving, via communication circuitry communicatively coupled to the processor, a signal wirelessly transmitted from a customer mobile device and carrying information relating to an image of a print media coupon captured by a camera on-board the customer mobile device and to a specified one of a plurality of virtual coupon repositories stored in a database also communicatively coupled to the processor, the database further having stored therein a plurality of customer accounts each for a different customer member of a coupon service hosted by the retail enterprise, with each customer account including a customer identifier identifying the customer associated with that customer account and linked to one of the plurality of virtual coupon associated only with that customer,
processing the wirelessly received information to determine therefrom a corresponding virtual print media coupon,
storing the virtual print media coupon in the specified one of the plurality of virtual coupon repositories,
receiving, via a point-of-sale terminal communicatively coupled to the processor, in response to customer interaction therewith as part of a transaction for the purchase of one or more items from the retail enterprise, the customer identifier associated in the database with the specified one of the plurality of virtual coupon repositories,
processing, via at least one of the processor and the point-of-sale terminal, the one or more items in the purchase transaction,
comparing the one or more items in the purchase transaction with the virtual print media coupon stored in the specified one of the plurality of virtual coupon repositories, and
deducting, via at least one of the processor and the point-of-sale terminal, a discount amount of the stored virtual print media coupon from a price of any item in the purchase transaction that matches the stored virtual print media coupon.

16. The non-transitory machine-readable medium of claim 15, wherein the plurality of instructions further include instructions, which when by the at least one processor, result in the at least one processor deleting the virtual print media coupon from the specified one of the plurality of virtual coupon repositories following deduction of the discount amount thereof from a matching one of the items processed by the point-of-sale terminal.

17. The non-transitory machine-readable medium of claim 15, wherein the plurality of instructions further include instructions, which when by the at least one processor, result in the at least one processor wirelessly receiving the information relating to the image of a print media coupon captured by the camera on-board the customer mobile device from a print media coupon printed on a tangible medium.

18. The non-transitory machine-readable medium of claim 15, wherein the plurality of instructions further include instructions, which when by the at least one processor, result in the at least one processor wirelessly receiving the information relating to the image of a print media coupon captured by the camera on-board the customer mobile device from an image of the print media coupon displayed on a display of an electronic device.

19. The non-transitory machine-readable medium of claim 15, wherein the information relating to an image of the print media coupon is the virtual print media coupon created by the customer mobile communication device from the image of the print media coupon,
and wherein the plurality of instructions further include instructions, which when by the at least one processor, result in the at least one processor processing the wirelessly received information to determine therefrom the corresponding virtual print media coupon by extracting the received virtual print media coupon from the wirelessly received signal.

20. The non-transitory machine-readable medium of claim 15, wherein the information relating to an image of the print media coupon is the image of the print media coupon,
and wherein the plurality of instructions further include instructions, which when by the at least one processor, result in the at least one processor processing the wirelessly received information to determine therefrom the corresponding virtual print media coupon by extracting coupon information from the wirelessly received image and creating the virtual print media coupon from the extracted coupon information.
